(19) United States
(12) Patent Application Publication
(10) Pub. No.: US 2024/0218167 A1
(43) Pub. Date: Jul. 4, 2024

(54) LIQUID APPLIED SOUND DAMPING MATS FOR FLOORING AND COMPOSITIONS FOR MAKING THEM

(71) Applicant: Dow Global Technologies LLC, Midland, MI (US)

(72) Inventors: Liang Zhang, Shanghai (CN); Wei Li, Shanghai (CN)

(21) Appl. No.: 18/577,742

(22) PCT Filed: Sep. 15, 2021
(86) PCT No.: PCT/CN2021/118445

§ 371 Date: Jan. 9, 2024

(51) Int. Cl. C08L 23/16; C08J 9/00; C08J 9/28; C08K 3/36; C08K 5/098; E04F 15/20

(52) U.S. Cl. CPC C08L 23/16; C08J 9/0061; C08J 9/283; C08K 3/36; C08K 5/098; E04F 15/203; C08J 2323/16; C08J 2409/06; C08J 2417/00; C08J 2425/14; C08J 2499/00; C08K 2201/005; C08L 2201/52; C08L 2203/14; C08L 2205/025; C08L 2205/035; C08L 2207/24

(57) ABSTRACT

The present invention relates to trowelable aqueous compositions for making rubbery composite mats for flooring and subflooring comprising an aqueous polymer foam forming component of A) one or more hard vinyl or acrylic aqueous emulsion polymers, preferably, acrylic or styrene acrylate aqueous emulsion polymers, and B) one or more soft vinyl or acrylic aqueous emulsion polymers, preferably, acrylic or styrene acrylate aqueous emulsion polymers and, as a rubbery composite component, C) (i) lightweight inorganic aggregates having a density of from 0.18 to 0.4 g/cm³, and C) (ii) one of or a combination of (a) crosslinked rubber granules and (b) finely divided crosslinked rubber particles. The trowelable aqueous compositions of the present invention provide seamless sound damping mats comprising the emulsion polymers A) and B) in a foam comprising a dispersion the granular and finely divided crosslinked rubber particles. The trowelable aqueous compositions may further comprise a thickener and an organic foaming agent.

### FIELD

The present invention relates to rubbery composite mats for flooring and subflooring comprising a polymer foam matrix of A) one or more hard vinyl or acrylic aqueous emulsion polymers, preferably, acrylic or styrene acrylate aqueous emulsion polymers, and B) one or more soft vinyl or acrylic aqueous emulsion polymers, preferably, acrylic or styrene acrylate aqueous emulsion polymers and, dispersed in the matrix, C)(i) granular inorganic aggregates and (ii) a combination of granular and finely divided crosslinked rubber particles, and trowelable aqueous compositions comprising aqueous emulsion polymers A) and B) in a foam and the granular and finely divided rubber particles. More particularly, the present invention relates to rubbery composite mats comprising a polymer foam matrix of A) one or more hard acrylic or styrene acrylate aqueous emulsion polymers and B) one or more soft acrylic or styrene acrylate aqueous emulsion polymers, the polymer foam matrix further comprising (i) a foam stabilizer of a 12 to 24 carbon organic acid salt, such as a calcium fatty acid salt, and (ii) an organic foaming agent, such as an alkyl polyglucoside, and, dispersed in the matrix, C)(i) lightweight inorganic aggregates having a sieve particle size of from 0.3 to 4 mm and having a density of from 0.18 to 0.4 g/cm³, such as, for example, a lightweight porous sand or silicate, and (ii) a combination of granular and finely divided crosslinked rubber particles, and to trowelable aqueous compositions comprising the polymer foam and the granular and finely divided rubber particles. The invention further relates to methods for using the trowelable aqueous compositions comprising mixing, as one component, the C)(i) inorganic aggregates and (ii) the granular or finely divided crosslinked rubber particles, or a combination thereof, with a separate aqueous component comprising a foam of the aqueous emulsion polymers A) and B) to make a trowelable mixture or mortar, and applying the mortar to a substrate, such as concrete or subflooring.

### INTRODUCTION

Acoustic insulation meets a growing need in construction, such as in multi-family residential building construction. Noise pollution may contribute to ailments that include stress-related illnesses, high blood pressure, hearing loss, sleep disruption, and lost productivity. In particular, noise from upper floors of buildings having multiple stories has proven to be a major source of noise pollution, especially sound caused by high heels, chairs, falling objects, etc. Currently, noise pollution adversely affects the lives of millions of people around the world and has increasingly become subject to regulation. In parts of China, one layer of sound damping material has recently been required for floating floors to achieve the relevant code specifications in residential buildings. Further, conventional sound insulation materials used in the market, such as various polystyrene foam, for example, EPS foam or XPS foam materials, glass fiber wool and precast polyurethane foam mats, present many issues including problems with leveling, cracking, odor and toxic fumes, and volatile organic compound (VOC) emissions, as well as the need for additional joint treatments for precast mats, the presence of sound bridges and etc.

WO2015051526A1 to Dow Global Technologies LLC discloses multilayer articles for use in surfacing a running track, wherein each of the top layer and base layer of the multilayer article comprise a layer of an acrylic emulsion polymer having a measured glass transition temperature (measured Tg) of −5° C. or less, a second, harder acrylic emulsion polymer having a measured Tg of 15° C. or more, a crosslinking agent, and vulcanized or crosslinked rubber particles having a sieve particle size of from 0.1 to 6 mm. The compositions used to form the layers of the multilayer article are not shelf-stable, lack the porosity to give acceptable indoor sound damping, and do not enable a low toxicity and odor free composition that can be used indoors.

The present inventors have sought to provide a seamless, low odor sound damping mat suitable for use in residential flooring and to provide for making the sound damping mat a shelf-stable, low VOC waterborne or aqueous composition, such as a two-component aqueous composition, which can safely be mixed, applied and used at a job site.

### SUMMARY

In accordance with the present invention, a trowelable aqueous composition of an aqueous polymer foam forming component and a rubbery composite component comprises:
as the aqueous polymer foam forming component:
A) from 10 to 60 wt. % or, preferably, from 15 to 50 wt. % of one or more hard vinyl or acrylic aqueous emulsion polymers, preferably, acrylic or styrene acrylate aqueous emulsion polymers, having a measured glass transition temperature (measured Tgh) of from 5 to 40° C. or, preferably, 10 to 35° C. or, preferably, 15 to 30° C., as measured by differential scanning calorimetry (DSC) comprising heating to 160° C., rapidly cooling at 10° C./minute to −80° C., and then collecting DSC curve data while ramping the temperature at 10° C./minute up to 160° C., and recording the midpoint of the inflection of the resulting DSC curve as the Tgh,
B) from 5 to 50 wt. % or, preferably, from 7 to 40 wt. % of one or more soft vinyl or acrylic aqueous emulsion polymers, preferably, acrylic or styrene acrylate aqueous emulsion polymers, having a measured glass transition temperature (measured Tgs) of from 5 to −35° C. or, preferably, −8 to −35° C. or, preferably, from −10 to −25° C., or, preferably, from −10 to −17° C. as measured by differential scanning calorimetry (DSC) comprising heating to 160° C., rapidly cooling at 10° C./minute to −80° C., and then collecting DSC curve data while ramping the temperature at 10° C./minute up to 160° C., and recording the midpoint of the inflection of the resulting DSC curve as the Tgs;
C)(i) from 0.5 to 3 wt. % of a foam stabilizer of a 12 to 24 carbon organic acid salt, such as a calcium fatty acid salt, preferably, calcium stearate, and C)(ii) from 0.05 to 0.75 wt. % or, preferably, from 0.1 to 0.5 wt. % of an organic foaming agent, preferably alkyl polyglucoside; and,
as the rubbery composite component:
D)(i) from 20 to 60 wt. % or, preferably, from 20 to 48 wt. % of a lightweight inorganic aggregate having a sieve particle size of from 0.3 to 4 mm, or from 0.3 to 3 mm, or, preferably, from 0.5 to 2.5 mm, and having a density of from 0.18 to 0.4 g/cm³, or, preferably, from 0.24 to 0.37 g/cm³, such as, for example, a lightweight porous sand, mesoporous silica, mesostructured silica or expanded clay aggregate; and,
D)(ii) from 20 to 60 wt. %, or from 20 to 48 wt. % of crosslinked rubber (a) granules having a sieve particle size of from 0.5 to 4 mm, or from 0.5 to 3 mm, or, such as from 0.5 to 2.5 mm, preferably, ethylene propylene diene (EPDM) rubber or ethylene propylene (EPM) rubber granules, or (b) particles having a sieve particle size of from 0.1 to less than 0.5 mm, preferably, EPDM or EPM rubber powder, or, preferably, a mixture, of the (a) granular crosslinked rubber particles, and the (b) finely divided crosslinked rubber particles, such as in a weight ratio of (a):(b) of from 99:1 to 20:80,
wherein all wt. % s in the trowelable aqueous composition add up to 100% and are based on the total weight of all materials used to form the trowelable aqueous composition. Further, the weight ratio of the rubbery composite component to the aqueous polymer foam forming component may range from 1:3 to 2:1 or, for example, 1:2 to 2:1. Still further, the solids weight ratio of the total A) hard vinyl or acrylic aqueous emulsion polymer to the total B) soft vinyl or acrylic aqueous emulsion polymer may range from 2:3 to 6:1 or, preferably, from 3:2 to 5:1. Preferably, the weight ratio of the D)(i) lightweight inorganic aggregate to the total weight of aqueous emulsion polymers A) and B) in the trowelable aqueous compositions ranges 1:1 or less, such as from 1:4 to 1:1.

The trowelable aqueous compositions in accordance with the present invention may further comprise, in the aqueous polymer foam forming component, any of from 0.1 to 1.5 wt. % of one or more thickeners, such as an anionic thickener or, preferably, a hydrophobically modified anionic thickener; or, from 0.1 to 1.5 wt. % of one or more dispersants, such as a sodium polycarboxylate dispersant; or a combination thereof. Still further, the trowelable aqueous compositions may comprise added water, for example, in the amount of from 10 to 50 wt. %, or from 20 to 50 wt. %, based on the total weight of all materials used to form the trowelable aqueous composition. The water may be added to the aqueous polymer foam forming component to improve its workability.

Preferably, the measured Tg (measured Tgh) of the A) hard vinyl or acrylic aqueous emulsion polymer and the measured Tg (measured Tgs) of the B) soft vinyl or acrylic aqueous emulsion polymer differ by 15° C. or more, such as from 15 to 75° C. or, preferably, 20° C. or more. The trowelable aqueous compositions in accordance with the present invention may further comprise, in the rubbery composite component, any one or more of from 0 to 10 wt. % of wood fibers or coconut fibers or a combination thereof, such as wood and/or coconut fibers having an average length of less than 12 mm.

In another aspect in accordance with the present invention, a rubbery composite sound damping mat for flooring and subflooring comprises:
a polymer foam matrix of A) from 10 to 60 wt. % or, preferably, from 15 to 50 wt. % of to one or more hard vinyl or acrylic aqueous emulsion polymers, preferably, acrylic or styrene acrylate aqueous emulsion polymers, having a measured glass transition temperature (measured Tgh) of from 5 to 40° C. or, preferably, 10 to 35° C. or, preferably, 15 to 30° C. as measured by differential scanning calorimetry (DSC) comprising heating to 160° C., rapidly cooling at 10° C./minute to −80° C., and then collecting DSC curve data while ramping the temperature at 10° C./minute up to 160° C., and recording the midpoint of the inflection of the resulting DSC curve as the Tgh, and B) from 3 to 35 wt. % or, preferably, from 5 to 32 wt. % of one or more soft vinyl or acrylic aqueous emulsion polymers, preferably, acrylic or styrene acrylate aqueous emulsion polymers, having a measured glass transition temperature (measured Tgs) of from 5 to −35° C. or, preferably, −8 to −35° C. or, preferably, from −10 to −25° C., or, preferably, from −10 to −17° C. as measured by differential scanning calorimetry (DSC) comprising heating to 160° C., rapidly cooling at 10° C./minute to −80° C., and then collecting DSC curve data while ramping the temperature at 10° C./minute up to 160° C., and recording the midpoint of the inflection of the resulting DSC curve as the Tg;
the polymer foam matrix further comprising C)(i) from 0.5 to 5 wt. % of a foam stabilizer of a 12 to 24 carbon organic acid salt, such as a calcium fatty acid salt, and C)(ii) from 0.05 to 1 wt. % or, preferably, from 0.1 to 0.75 wt. % of an organic foaming agent, such as an alkyl polyglucoside; and,
dispersed in the polymer foam matrix from 30 to 70 or, preferably, from 35 to 60 wt. % of a rubbery composite of D)(i) from 25 to 75 wt. %, or from 25 to 65 wt. % of a lightweight inorganic aggregate having a sieve particle size of from 0.3 to 4 mm, or from 0.3 to 3 mm, or, preferably, from 0.5 to 2.5 mm, and having a density of from 0.18 to 0.4 g/cm³, or, preferably, from 0.24 to 0.37 g/cm³, such as, for example, a lightweight porous sand, mesoporous silica, mesostructured silica or expanded clay aggregate, and D)(ii) from 25 to 75 wt. %, or from 25 to 65 wt. % of crosslinked rubber (a) granules having a sieve particle size of from 0.5 to 4 mm, or from 0.5 to 3 mm, or, preferably, from 0.5 to 2.5 mm, preferably ethylene propylene diene (EPDM) rubber or ethylene propylene (EPM) rubber granules, or (b) finely divided crosslinked rubber particles having a sieve particle size of from 0.1 to less than 0.5 mm, preferably, EPDM rubber or EPM rubber powder, or a mixture of the (a) granular crosslinked rubber particles and the (b) finely divided crosslinked rubber particles, such as in a weight ratio (a):(b) of from 99:1 to 20:80 of (a),
wherein all wt. % s in the polymer foam matrix add up to 100% and are based on the total weight of materials used to form the polymer foam matrix; and,
further wherein, all wt. % s in the rubbery composite add up to 100% and are based on the total weight of materials used to form the rubbery composite.

Preferably, where the rubbery composite component of the trowelable aqueous compositions or the sound damping mat comprise a mixture of D)(ii) crosslinked rubber (a) granules and (b) finely divided crosslinked rubber particles, the weight ratio of the D)(ii)(a) granular crosslinked rubber particles and the D)(ii)(b) finely divided crosslinked rubber particles may range from 12:1 to 1:2, or, preferably, from 4:1 to 1:1.2.

In yet another aspect, the present invention further relates to methods for using the trowelable aqueous compositions comprising:
mixing the D)(i) inorganic aggregates and D)(ii) the mixture of (a) granular crosslinked rubber and (b) finely divided crosslinked rubber particles to form a rubbery composite component;
mixing or, preferably, mixing and shearing, mixing and agitating or a combination of mixing, shearing and agitating, the aqueous emulsion polymers A) and B), the C)(i) foam stabilizer, and C)(ii) the organic foaming agent to form an aqueous polymer foam forming component;
combining the rubbery composite component and the aqueous polymer foam forming component to make a trowelable mixture; and,
applying the trowelable mixture to a substrate, such as concrete or subflooring, to form a mat layer. The methods may further comprise drying or curing the mat layer, such as by allowing the mat layer to rest for 20 to 60 hours, preferably, without heat.

In the methods in accordance with the present invention, the weight ratio of the rubbery composite component to the aqueous polymer foam forming component may range from 1:3 to 2:1 or, for example, 1:2 to 2:1 regardless of solids content. Accordingly, the materials are mixed, poured or applied and then dried or cured.

### DETAILED DESCRIPTION OF THE DRAWINGS

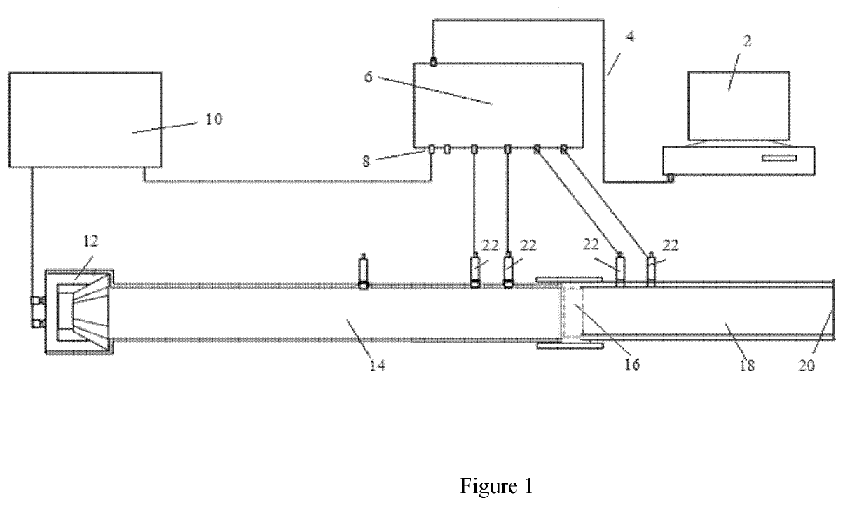

FIG. 1 depicts an example of an acoustic impendence tube test set up used to test the sound damping mats made in accordance with the present invention.

### DETAILED DESCRIPTION OF THE PRESENT INVENTION

In accordance with the present invention, sound damping mats that provide adequate compression resistance for use in flooring applications comprise an aqueous acrylic or vinyl polymer foam forming matrix component, and a dispersed composite of a lightweight aggregate and at least one of or a mixture of crosslinked rubber granules and a crosslinked rubber powder. The dampling mats exhibit good sound damping in impact noise and acoustic impedance testing, a low compression rate, provide some heat insulation, have a low odor and are made from less toxic materials. The mats themselves are continuous, formed in the same manner as a mortar layer, and can be made to any desired shape. Thus, the mats are seamless, seal completely to all surfaces, borders and edges, and leave or create no sound bridges. As the materials are aqueous, they are not flammable in use. However, the sound damping mats themselves are fully dry and waterproof, providing relatively low water absorption and presenting a low risk of molding and rotting issues.

Unless otherwise indicated, conditions of temperature and pressure are room temperature (23±2° C.) and standard pressure (101.3 kPa, also referred to as “ambient conditions”. And, unless otherwise indicated, all conditions include a relative humidity (RH) of 50 10%.

Unless otherwise indicated, any term containing parentheses refers, alternatively, to the whole term as if no parentheses were present and the term without them, and combinations of each alternative. Thus, the term “(meth)acrylate” refers, independently, to acrylate, methacrylate, their mixtures or a combination or two or more thereof.

The singular forms “a,” “an,” and “the” include plural referents unless the context clearly dictates otherwise. Unless defined otherwise, the terms used herein have the same meaning as is commonly understood by one skilled in the art.

All ranges are inclusive and combinable. For example, the term “a measured Tg of from 5 to 40° C. or, preferably, 10 to 35° C. or, preferably, 15 to 30° C. would include each of from 5 to 40° C. or, from 10 to 40° C., or, from 5 to 35° C., or, from 5 to 30° C., or from 5 to 15° C., or from 5 to 10° C., or, preferably, from 10 to 35° C. or, preferably, from 10 to 30° C., or, preferably, from 10 to 15° C. or, from 15 to 40° C., or, preferably, from 15 to 30° C., or, preferably, from 15 to 35° C., or from 30 to 40° C., or, preferably, 30 to 35° C. or, from 35 to 40° C.

As used herein, the term “aqueous” refers to a carrier or solvent comprising water and up to 10 wt. % of total solvent or carrier of one or more water miscible organic solvents, such as alkyl ethers.

As used herein, the term “ASTM” refers to publications of ASTM International, West Conshohocken, PA.

As used herein, the term “BS EN” that contains a number and a publication date refers to an engineering standard as published by BSI Standards Limited, 389 Chiswick High Road, London, W4 4AL, U.K.

As used herein, the terms “GB” or “GB/Z” or “GB/T” that contain numbers and publication dates refer to various China National standards as published by the China Standards Press, No. 2A, West Heping Street, Chaoyang District, Beijing 100029, China.

As used herein, the term “calculated glass transition temperature” or “calculated Tg” means the value calculated using the Fox equation (Fox, Bull. Am. Physics Soc., Volume 1, Issue No. 3, page 123(1956)), as follows:

1/Tg(calc.)=Σw(M₁)/Tg(M₁)+w(M₂)/Tg(M₂)+ . . . w(Mₙ)/Tg(Mₙ)
wherein Tg(calc.) is the glass transition temperature calculated for the copolymer,
w(M₁) is the weight fraction of monomer M1 in the copolymer,
w(M₂) is the weight fraction of monomer M2 in the copolymer,
w(Mₙ) is the weight fraction of monomer Mn in the copolymer,
Tg(M₁) is the glass transition temperature of the homopolymer of M1,
Tg(M₂) is the glass transition temperature of the homopolymer of M2, and
Tg(Mₙ) is the glass transition temperature of the homopolymer of Mn
all temperatures being in ° K.

The glass transition temperatures of homopolymers may be found, for example, in Polymer Handbook, edited by J. Brandrup and E.H. Immergut, Wiley Interscience Publishers, New York, 1999 at pages VI/193-277.

As used herein, the term “measured Tg” means the glass transition temperature or Tg of a given polymer composition as measured by differential scanning calorimetry (DSC) using, for example, a TA Instruments Q2000 (TA Instruments, New Castle, DE) calorimeter where a sample of the polymer composition was heated to 160° C., rapidly cooled at 10° C./minute to −80° C., and then the data were collected while ramping the temperature at 10° C./minute up to 160° C., and recording the midpoint of the inflection of the resulting DSC curve as the Tg.

As used herein, the term “polymer” means a macromolecular compound prepared by reacting (i.e. polymerizing) monomers of the same or different type, and includes both homopolymers and copolymers of all kinds. The term “copolymer” means a polymer prepared by the polymerization of at least two different monomers as reactants, including copolymers prepared from two different monomers, as well as polymers prepared from more than two different monomers, e.g., terpolymers, tetrapolymers (four different monomers), and so on. As used herein, the term “homopolymer” denotes a polymer comprising repeating units derived from a single monomer, but does not exclude residual amounts of other components used in preparing the homopolymer, such as chain transfer agents.

As used herein, the term “solids” or “total solids” refers to any materials that do not volatilize upon cure or during application of the compositions in accordance with the present invention regardless of their state of matter. Water, ammonia, unreactive volatiles, liquid carriers, and volatile solvents are not considered to be solids. Further, unless otherwise stated, the term “solid” when referring to an individual substance refers to a crystalline or amorphous substance that does not flow perceptibly under moderate stress, has a definite capacity for resisting forces which tend to deform it, and under ordinary conditions retains a definite size and shape.

As used herein, the term “substantially free of volatile organic compounds” means that a composition contains less than 100 g/l or 100 g/kg, based on the total weight of the composition, or, preferably, less than 50 g/l or 50 g/kg of the total amount of organic solvents, including amines, ethers, glycols, and all other organic solvents in a given composition.

The aqueous polymer foam forming component comprises a blend of A) one or more hard vinyl or acrylic aqueous emulsion polymers and a hard vinyl or acrylic aqueous emulsion polymer. The combination of hard and soft polymers enables ready foam formation with sufficient resilience to provide foams that do not collapse in flooring applications.

The vinyl or acrylic emulsion polymers useful in the present invention may comprise one or more copolymerized ethylenically unsaturated nonionic vinyl or acrylic monomers. As used herein, the term “Nonionic monomers” refers to polymerizable monomers that do not bear an ionic charge at from pH=1-14. Examples of suitable ethylenically unsaturated nonionic monomers include (meth)acrylic ester monomers and arylene monomers such as methyl acrylate, ethyl acrylate, butyl acrylate, 2-ethylhexyl acrylate, nonyl acrylate, decyl acrylate, lauryl acrylate, hydroxyethyl acrylate, hydroxypropyl acrylate, methyl methacrylate, ethyl methacrylate, butyl methacrylate, nonyl methacrylate, isodecyl methacrylate, lauryl methacrylate, hydroxyethyl methacrylate, 1,3-butanediol dimethacrylate, and hydroxypropyl methacrylate; styrene and alkyl substituted styrene; (meth)acrylamide; (meth)acrylonitrile; or mixtures thereof. The ethylenically unsaturated nonionic monomers preferably comprise (meth)acrylic ester monomers, or their combination with styrene.

The hard vinyl or acrylic emulsion polymers A) useful in the present invention may comprise in polymerized form, based on the solids weight of the emulsion polymer A), a total of 70 wt. % or more, or 75 wt. % or more, or 80 wt. % or more, or, 99.5 wt. % or less, 95 wt. % or less, or 90 wt. % or less of any one or more copolymerized nonionic monomers. The soft vinyl or acrylic emulsion polymers B) useful in the present invention may comprise in polymerized form, based on the solids weight of the emulsion polymer B), a total of 70 wt. % or more, or 75 wt. % or more, or 80 wt. % or more, or, 99.5 wt. % or less, 95 wt. % or less, or 90 wt. % or less of any one or more copolymerized nonionic monomers.

Each of the hard and soft vinyl or acrylic aqueous emulsion polymers A) and B) useful in the present invention may comprise one or more copolymerized ethylenically unsaturated monomers having one or more functional groups. The functional groups may be selected from carboxyl, carboxylate, carbonyl, acetoacetate, alkoxysilane, carboxyl, ureido, amide, imide, amino group, or mixtures thereof. Preferably, an ethylenically unsaturated monomer bearing a carboxyl or a carboxylate group, such as methacrylic acid or its salt is used. Examples of suitable functional-group-containing ethylenically unsaturated monomers include ethylenically unsaturated carboxylic or dicarboxylic acids such as acrylic or methacrylic acid, itaconic acid, and maleic acid; amides, and preferably N-alkylolamides or hydroxyalkyl esters of the above-mentioned carboxylic acids, such as acrylamide, methacrylamide, N-methylolacrylamide, N-methylolmethacrylamide, 2-hydroxyethylacrylamide, 2-hydroxyethylmethacrylamide, hydroxyethyl acrylate, hydroxy ethyl methacrylate, hydroxypropyl acrylate and hydroxypropyl methacrylate; or mixtures thereof. Adhesion promoting functional groups may comprise, for example, acetoacetate, alkoxysilane, carboxyl, ureido, or amino groups.

The hard vinyl or acrylic emulsion polymers A) useful in the present invention may comprise in polymerized form, based on the solids weight of the emulsion polymer A), a total of 0.01 wt % or more, or, 0.05 wt % or more, or, 0.1 wt % or more, or, 20 wt % or less, 10 wt % or less, or 5 wt % or less of any one or more copolymerized functional-group-containing ethylenically unsaturated monomers.

The soft vinyl or acrylic emulsion polymers B) useful in the present invention may comprise in polymerized form, based on the solids weight of the emulsion polymer B), a total of 0.01 wt. % 30 or more, or, 0.05 wt. % or more, or, 0.1 wt. % or more, or, 20 wt. % or less, 10 wt. % or less, or 5 wt. % or less of any one or more copolymerized functional-group-containing ethylenically unsaturated monomers.

Preferably, each of the hard vinyl or acrylic emulsion polymers A) and the soft vinyl or acrylic emulsion polymers B) comprises, in polymerized form, based on the solids weight of the polymer A) or B), respectively, from 70 to 99.5 wt. % in total of one or more copolymerized ethylenically unsaturated nonionic monomers, and from 0.5 to 10 wt. % in total of one or more copolymerized ethylenically unsaturated monomers having one or more functional groups.

The aqueous emulsion polymers A) and B) useful in the present invention may be prepared by polymerization techniques well known in the art, preferably, by aqueous free radical emulsion polymerization. Suitable aqueous emulsion polymerization techniques are well known in the polymer art, and include multiple stage polymerization processes. For a given monomer, the proportion of the monomer based on the total weight of monomers used in preparing the aqueous dispersion of the acrylic (co)polymer is substantially the same as the proportion of copolymerized such monomer based on the solids weight of the acrylic (co)polymer. One suitable aqueous emulsion polymerization method involves use of a surfactant. Suitable surfactants may include, for example, sodium laureth sulfate, sodium alkyl sulfosuccinate or an alkyl alcohol alkoxylate. The amount of the surfactant used ranges from 0.01 wt. % or more, 0.3 wt. % or more, or even 0.5 wt. % or more, and at the same time, 10 wt. % or less, 5 wt. % or less, or even 2 wt. % or less, based on the total weight of monomers used to make a given polymer.

To control the molecular weight of the obtained emulsion polymer, emulsion polymerization may be conducted in the presence of a chain transfer agent. Examples of suitable chain transfer agents include 3-mercaptopropionic acid, dodecyl mercaptan, methyl 3-mercaptopropionate, benzenethiol, azelaic alkyl mercaptan, or mixtures thereof. The concentration of the chain transfer agent in total may range 0.01 wt. % or more, 0.05 wt. % or more, or even 0.1 wt. % or more, or, 5 wt. % or less, 3 wt. % or less, or 2 wt. % or less, based on the total weight of monomers used to make the emulsion polymer.

Aqueous emulsion polymers A) and B) may have solids contents ranging 30 wt. % or more, 35 wt. % or more, or 40 wt. %% or more, or, 70 wt. % or less, 68 wt. % or less, or 65 wt. % or less, based on the total weight of the emulsion.

The hard vinyl or acrylic emulsion polymers A) useful in the present invention may have a measured Tgh of 5° C. or higher, 10° C. or higher, 15° C. or higher, or, 50° C. or lower, 35° C. or lower, or 30° C. or lower. Suitable commercially available hard vinyl or acrylic emulsion polymers A) may include, for example, RHOPLEX™ 2500 acrylic emulsion available from The Dow Chemical Company.

The soft vinyl or acrylic emulsion polymers B) useful in the present invention may have a measured Tgs of −5° C. or lower, or, −8° C. or lower, or −10° C. or lower, and at the same time, −50° C. or higher, −35° C. or higher, or −17° C. or higher. Suitable commercially available soft vinyl or acrylic emulsion polymers B) may include, for example, ELASTANE™ 2848NG, RHOPLEX™ EC-1791 and RHOPLEX™ EC-2540 acrylic emulsions both available from The Dow Chemical Company (ELASTANE and RHOPLEX are trademarks of The Dow Chemical Company (Dow)).

To improve foam durability in a mortar upon application, the aqueous polymer foam forming component further comprises C) (i) one or more foam stabilizers, such as a calcium stearate water emulsion, or salts of 12 to 18 carbon aliphatic acids or mixtures of aliphatic carboxylic acids of from about 16-20 carbons, particularly where the acid is saturated, for example, Na or K stearate; and salts of 12-24 carbon fatty acids, such as oleic acid, tallow fatty acids, and tall oil fatty acids. The total amount of the C)(i) one or more foam stabilizers may range from 0.5 to 3 wt. %, based on the total weight of all materials used to form the trowelable aqueous composition.

To form an air entraining matrix or foam, the aqueous polymer foam forming component further comprises C)(ii) one or more organic foaming agents, such as, for example, an alkyl polyglucoside foaming agent, an alkylsulfonate, such as sodium alkylsulfonate or sodium alkylbenzenesulfonate, or mixtures thereof. The C)(ii) organic foaming agent forms a foam of the aqueous emulsion polymer composition upon shearing and/or agitation of the composition. The total amount of the C)(ii) organic foaming agent may range from 0.05 to 0.75 wt. %, such as from 0.05 to 0.5 wt. %, or, preferably, from 0.1 to 0.5 wt. %, based on the total weight of all materials used to form the trowelable aqueous composition.

To preserve consistency and homogeneity in the trowelable aqueous compositions of the present invention, one or more thickeners may be included, such as a hydrophobically modified anionic thickener, a hydrophobically modified alkali swellable emulsion (HASE), for example, hydrophobically modified acrylic acid copolymers such as ACRYSOL™ TT935 (Dow). A hydrophobically modified acrylic acid copolymer comprises two or more hydrophobic groups, such as an aryl or phenyl group, or a C₄ or higher alkyl group. The total amount of the one or more thickeners may range from 0.05 to 1.5 wt. %, such as from 0.1 to 1.5 wt. %, based on the total weight of all materials used to form the trowelable aqueous composition.

To improve the homogeneity of the trowelable aqueous compositions, the aqueous polymer foam forming component may further comprise one or more dispersants, e.g. an alkali metal polycarboxylate, such as sodium polyacrylate. A suitable sodium polymethacylic acid dispersant is sold as OROTAN™ 1850E (Dow). The total amount of the one or more dispersants may range from 0.05 to 1.5 wt. %, such as from 0.1 to 1.5 wt. %, based on the total weight of all materials used to form the trowelable aqueous composition.

To improve overall workability of the trowelable aqueous compositions of the present invention, a small amount of water may be added to the aqueous polymer foam forming component when mixing it with the rubbery composite component. The amount of added water may range from 0 to 50 wt. %, based on the total weight of all materials used to form the trowelable aqueous composition.

The rubbery composite component of the trowelable aqueous compositions in accordance with the present invention comprises D)(i) a lightweight inorganic aggregate which enables durable porosity in the damping mats made therefrom. A suitable porous lightweight aggregate may include, for example, lightweight sand, or a sintered silicate or clay. The D)(i) lightweight inorganic aggregate may have a density of from 180 to 400 kg/m³(0.18 to 0.4 g/cm³) or from 240 to 370 kg/m³ (0.24-0.37 g/cm³). A suitable lightweight inorganic aggregate may have a sieve particle size of from 0.3 to 4 mm, or, from 0.3 to 3 mm, or, from 0.3 to 2.5 mm, or from 0.7 to 2 mm or, preferably, from 0.5 to 2.5 mm. The total amount of the D)(i) lightweight inorganic aggregate may range from 15 to 60 wt. %, or from 20 to 60 wt. % or, preferably, from 25 to 55 wt. % or, preferably, from 25 to less than 50 wt. %, based on the total weight of all materials used to form the trowelable aqueous composition.

The rubbery composite component further comprises D)(ii) finely divided crosslinked rubber particles as particles or finely divided powder, granules, or a mixture thereof. The (a) crosslinked rubber granules are larger than the (b) finely divided crosslinked rubber particles. The (a) crosslinked rubber granules may have a sieve particle size of from 0.5 to 4 mm, or, for example, from 0.5 to 2.5 mm. The (a) crosslinked rubber particles have a sieve particle size of less than 0.5 mm. The crosslinked rubber improves sound insulation. Preferably, to reduce odor and toxicity, the D)(ii)a) crosslinked rubber granules or particles comprise ethylene propylene diene (EPDM) rubber.

The total amount of the D)(i) lightweight inorganic aggregate may range from 20 to 60 wt. % or, preferably, from 25 to 55 wt. %, based on the total weight of all materials used to form the trowelable aqueous composition.

The amount of the D)(ii) crosslinked rubber (a) granules and/or (b) finely divided particles may be increased relative the amount of the D)(i) lightweight inorganic aggregate to improve the crack resistance, sound damping and resiliency of the sound damping mats. Preferably, the total amount of the rubbery composite component in the trowelable aqueous compositions may be selected such that when the trowelable aqueous compositions are dried or cured to form a sound damping mat, the total weight ratio of rubbery composite component solids to aqueous polymer foam forming component solids ranges from 1:3 to 2:1, such as from 1:3 to 2.5:1 or, for example, 1:2 to 2:1, or, for example, 1:1.6 to 2:1.

Any kind of crosslinked or vulcanized rubber, such as, for example, natural rubber, synthetic rubber, and derivatives thereof may be used as the D)(ii) (a) granules and/or (b) particles in the rubbery composite component of the present invention. Suitable rubbers may include, for example, diene-based polymers such as polyisoprene, cis-1,4-polyisoprene, EPDM, ethylene propylene rubber (EPM), butadiene rubber, nitrile rubber, including nitrile diene rubber, such as acrylonitrile butadiene styrene rubber (ABS), styrene butadiene rubber (SBR), acrylonitrile-butadiene, cis-1,4-polybutadiene, crosslinked acrylic rubber, hydrogenated nitrile, nitrile rubber, neoprene rubber, chloroprene rubber, halogenated butyl rubber, and recycled rubber, such as, recycled tire rubber or ground tire rubber (GTR). The crosslinked rubber may be vulcanized (crosslinked) or hyperoxidized rubber and may contain one or more of a crosslinking agent, sulfur, or vulcanizing accelerator. Preferably, the crosslinked rubber (a) granules and/or (b) particles of the present invention, are low odor, sulfur free and free of toxic materials, such as heavy metals. Examples of preferred crosslinked rubber (a) granules and/or (b) particles are EPDM, EPM and SBR.

The D)(ii) (b) crosslinked rubber particles of the present invention may comprise a finely divided crosslinked rubber and may have a sieve particle size less than 0.5 mm, less than 0.3 mm, less than 0.1 mm, or even less than 0.05 mm; or it may comprise granules having a sieve particle size of from 0.5 to 4 mm, or from 0.5 to 3 mm, or, preferably, from 0.5 to 2.5 mm; or it may comprise a mixture of the finely divided crosslinked rubber and the crosslinked rubber granules.

For use as sound damping mats in floor mat, subfloor and underlayment applications in accordance with the present invention or compositions for making the sound damping mats, the trowelable aqueous compositions must withstand compressive force without more than minor shrinkage, such as, for example, less than 5% and as little as, for example, 0.05%, such as, preferably, less than 3% or, more preferably, 2% or less of the original thickness of the sound damping mat or layer of dry or cured material comprising the sound damping mat. Preferably, the weight ratio of the D)(i) lightweight inorganic aggregate to the total weight of aqueous emulsion polymers A) and B) in the trowelable aqueous compositions ranges 1:1 or less, such as from 1:4 to 1:1. Thus, the weight ratio of the D)(i) lightweight inorganic aggregate solids to the total solids weight of the aqueous emulsion polymers A) and B) may preferably range 3:1 or less, such as from 1:8 to 2.5:1.

For further sound insulation and tensile strength improvement, the rubbery composite component and dispersed rubbery composite portion of the of the present invention may further comprise wood fibers or coconut fibers, such as any having an average length of less than 12 mm, or less than 10 mm. The total amount of such wood or coconut fibers may range from 0 to 10 wt. %, based on the total weight of all materials used to form the trowelable aqueous composition.

The present invention is not limited by the shape of the D)(ii) finely divided crosslinked rubber (a) granules and/or (b) particles. The crosslinked rubber may be, for example, in shredded form, rubber pellets, rubber strands, or particles such as crumb rubber, or a rubber powder, which particulate forms are available commercially and produced by methods known to those skilled in the art.

In accordance with methods for using the trowelable aqueous compositions of the present invention, the mixing, separately and, independently, of each of the aqueous polymer foam forming component and the rubbery composite component may be carried out by any conventional means for forming a mortar or simple mixing. For example, each component may be mixed by hand or with a low shear mixer, such as a cement mixer. Prior to mixing it with the rubbery composite component, the aqueous polymer foam forming component can be foamed using a static mixer or a medium or high shear mixer, such as a homogenizer or other conventional foam mixing device. Prior to mixing it with the aqueous polymer foam forming component, the rubbery composite component of the present invention is mixed dry. Further, the aqueous polymer foam forming component and the trowelable aqueous compositions may be mixed in the same mixer as either the aqueous polymer foam forming component or the rubbery composite component itself was mixed.

In the methods of the present invention, applying the trowelable aqueous compositions of the present invention to form the sound damping mat may comprise applying the compositions to concrete slabs, i.e. on top of them, to form a layer in a conventional manner, for example, by using a trowel, squeegee, roller, scree and/or a float, such as in the manner of plaster, a render or a skim coat.

After the drying or curing of the trowelable aqueous compositions, the methods of the present invention may further comprise applying cement, plaster or a gypsum skim coat to complete a sub floor installation.

### Examples

The following examples illustrate the present invention. Unless otherwise indicated, all parts and percentages are by weight and all temperatures are in ° C. and all preparations and test procedures are carried out at ambient conditions of room temperature (23° C.) and pressure (1 atm). In the examples and Tables 1, 2, and 3 that follow, the following abbreviations were used: AA: Acrylic acid; AM: Acrylamide; BA: n-Butyl Acrylate; HEMA: 2-Hydroxyethyl Methacrylate; MAA: Methacrylic acid; MMA: Methyl methacrylate; Sty: Styrene.

The following materials were used in the Examples that follow (All commercial components were used as received):
Hard styrene acrylic emulsion polymer: Single stage styrene acrylic emulsion polymer made by gradual addition emulsion polymerization of 1.0 glacial acrylic acid (GAA)/2.0 AM/0.2 adhesion promoter monomer/47.8 Sty/49 BA and having a measured Tg (DSC TA Instruments Q2000 (TA Instruments, New Castle, DE); sample heated to 160° C. then rapidly cooled (10° C./min) to −80° C. for 3 min, then ramped at 10° C./minute to 160° C.) of 21° C.;
Soft styrene acrylic emulsion polymer: Single stage styrene acrylic emulsion polymer made by gradual addition emulsion polymerization of 0.5 HEMA/1.9 AM/28 Sty/69.6 BA and having a measured Tg of −11° C.;
Water: Tap water;
Foam Stabilizer: Xianbang C-405 Calcium stearate salt aqueous emulsion, Shanghai Xianbang Chemicals Co. Ltd, Shanghai, PRC;
Foaming Agent: TRITON™ CG-110 Alkyl polyglucoside foaming agent, The Dow Chemical Company (Dow), Midland, MI;
Thickener: Acrysol™ TT935 Hydrophobically modified anionic thickener, Dow;
Dispersant: Orotan™ 1850E Sodium polyacrylate, Dow
Lightweight sand: Sand, mainly composed of SiO₂ having a density of 0.27 g/cm³. (Suzhou Lvcheng Lightweight Green Materials Co. Ltd. Suzhou, PRC);
EPDM granules: Ethylene Propylene Diene (EPDM) Rubber sieve (particle size from 0.2 to 2 mm as reported by mfg., Guangzhou Chuanao Sports Facilities Co. Ltd., Guangzhou PRC);
EPDM Rubber powder: Sieve particle size 177 μm, <80 mesh (as reported by mfg., Guangzhou Chuanao Sports);
Recycled tire rubber powder: Size: <0.5 mm (as reported by mfg, Fujian Aoxiang, Fuzhou, PRC);
Recycled foam rubber powder from latex mattress (Jiangxi Wandao New Materials Co. Ltd., Nanchang, PRC);
SBR Recycled rubber powder (sieve particle size <0.5 mm as reported by mfg., Fujian Aoxiang);
Wood flour A: Size 1.18 mm or <16 mesh (as reported by mfg, SDC lab, Shanghai);
Wood flour B: Size 0.5 to 1.18 mm, or 16-30 mesh (as reported by mfg., SDC lab);
Coconut fiber: Length: <12 mm (as reported by mfg, KNAAP (Thailand) Co. Ltd.);
Precast PU Foam Mat: Polyurethane foam Guangzhou Baolai Acoustic Material Co., Ltd, Guangzhou) made through basic addition polymerization reaction involving a diol or polyol, and diphenyl-methane diisocyanate (MDI), and water and having a density of 700 kg/m³.

TABLE 1
Formulations For The Impact Sound Insulation Test

| | | Example | Example |
|---|---|---|---|
| Ingredient (Wt. %) | | 9B | 9C |
| Liquid | Hard styrene acrylic emulsion polymer | 9.78 | 9.78 |
| part | Soft styrene acrylic emulsion polymer | 48.90 | 48.90 |
| | Water | 39.12 | 39.12 |
| | Foam Stabilizer | 0.98 | 0.98 |
| | Foaming Agent | 0.14 | 0.14 |
| | Thickener | 0.59 | 0.59 |
| | Dispersant | 0.49 | 0.49 |
| Powder | Recycled tire rubber (<0.5 mm) | 29.87 | 18.99 |
| part | EPDM rubber powder | 57.14 | 55.70 |
| | Wood flour A | 12.99 | 0 |
| | Wood flour B | 0 | 12.66 |
| | Lightweight sand-270 | 0 | 12.66 |

| | | |
|---|---|---|
| Liquid part/Powder part | 0.753 | 0.773 |

* Denotes Comparative Example.

Damping Mats: Unless otherwise indicated, to make damping mats for the examples, the indicated materials in each of the liquid component and powder component were mixed separately according to the formulations shown in Table 1, above, and Tables 3 and 4, below, and were then homogeneously mixed together to form a mortar. The mortar was formed into a layer by pouring it onto a piece of release paper laid into a 300×300×5 mm stainless steel frame and levelling the thus poured mortar using a stainless steel trowel. For thinner mats, a lower proportion of mortar was poured into the frame. After curing for 24 hours, the mats were cut into the desired size for testing.

Thickness of the tested damping mats was determined in accordance with BS EN 12431:2013 Thermal insulating products for building applications—Determination of thickness for floating floor insulating products.

Test Methods: The following test methods were used in the examples that follow: Impact sound insulation: Damping mats used were 5 mm thick and had a rectangular surface the size of 22 cm L×30 cm W. The thickness of the mat in Example 1 was 3 mm and in Example 2 was 5 mm. A polystyrene foam board (5 cm thickness) right rectangular prism (box), open at the top was built to evaluate the impact sound insulation performance of different sound damping mat materials. The box had a height of 60 cm and interior cavity size of 30 cm W×20 cm L and across each of the back and front horizontally disposed rectangular holes (30 cm W×5 cm L) at a height of exactly 15 cm from the bottom. Sound damping mats were held in place between two polystyrene foam board “C” panels, each 30 cm long and having a square 5 cm×5 cm cross section having a 1 cm×1 cm channel or groove extending its length to receive each side of the damping mat and slid into the holes on the box so as to lie parallel to the bottom of the box. A steel ball (1000 g and 6.35 cm in diameter) was held at the level of the top of the box and dropped down from the top of the box onto each damping mat to generate an impact noise. A noise measuring instrument was placed below the sample holder inside the box for receiving sound noise below the damping mat. Each damping mat was measured 5 times and the average was reported. Precast PU foam mat samples having a thickness of 3 mm and 5 mm respectively were used for comparison. The results of the impact sound insulation test are shown in Table 5, below.

Acoustic Insulation Impedance Tube Test: The acoustic insulation impedance tube test was performed in accordance with GB/Z 27764-2011 Acoustics—Determination of sound transmission loss in impedance tubes—Transfer matrix method (China Standards Press, Beijing, China). To form each damping mat, each of the indicated mortars from Table 3, below, was allowed to cure at room temperature for 48 hours, and then each mat was cut into two round pieces with the diameters of 100 mm and 30 mm, respectively. The thickness of all the damping mats used, independently, in any of the Examples or Comparative Examples 1 to 11, below, were 5 mm. A precast PU foam mat having a thickness of 5 mm was used as Comparative Example 12 in the acoustic insulation impedance test. In the test, the equipment used comprises a series of two impedance tubes (SW series Shengwang Technology Company). The components of the apparatus are shown as situated in the test in FIG. 1 and comprise the damping mat (16) to be tested, one of a set of two impedance tubes (18) (individual tube not shown) of different maximum inner diameters (30 mm and 100 mm) and having tapering diameters, four sound pressure sensors comprising microphones (22), a power amplifier (10) linked to a four-channel data acquisition instrument (6) via a sound signal output (8) and also linked via a USB connection (4) to a PCU (2) running a software analysis system (VA-LAB Basic and IMP Module, Beijing Shengwang Acoustics Technology Corporation, Beijing). Impedance tube (14) includes sound source tube (14), and extended damping tube (18) or receiving tube and impedance tube end (20). The apparatus includes a loudspeaker (12) connected at the top or open end of impendence tube (14). When measuring the sound insulation performance of materials, a four-microphone sound transfer method comprised recording or sensing a different sound source tube (14) and receiving tube (18) for each microphone (22). The basic parameters during the test are shown in Table 2, below. To eliminate any loading error in the test, the result reported is the average of three independent experiments for each damping mat. The results are shown in Table 7, below. The data represent the effective sound insulation over a wide range of different frequencies.

TABLE 2
Parameters During Measurement of Acoustic Impedance

| | |
|---|---|
| Atmospheric temperature (° C.) | 10.0 |
| Relative humidity | 50% |
| Atmospheric pressure (Pa) | 101325.0 |
| Atmospheric density (kg/m³) | 1.2 |
| Sound speed (m/s) | 337.382 |
| Air characteristic impedance (Pa · s/m) | 414.055 |

Compression Rate: The indicated materials in each of the liquid part and powder part were mixed separately according to the formulations shown in Table 4, below, and used to make a mortar which was then formed into sound damping mats. After allowing the mats to cure at room temperature for 48 hours, each mat was cut into a 20 mm×20 mm square. The starting thickness of all the mats was roughly 5 mm. A precast PU foam mat having a thickness of 5 mm was used as Comparative Example 12. The thicknesses of the damping mats were measured under different loads: dL, thickness of the sample under a load of 250 Pa; dF, thickness of the sample under a load of 2 kPa; d50K, thickness of the sample under a load of 50 kPa; dB, thickness of the sample under a load of 2 kPa after application of a short time additional load (48 kPa). The thicknesses dL, dF, d50K and dB were determined sequentially, in order on the same damping mats after determining their initial thickness. The compression rate is calculated as [(dF−d50K)/dF]×100%. The results are shown in Table 6, below. The method to measure the thickness after compression testing was, as follows:

Each damping mat was lain on a rigid, flat and horizontal base plate, with any facing or coating against the base plate and ensuring that the full mat surface area of each damping mat was in contact with the base plate. To measure 4 L each damping mat tested was loaded with a device exerting a pressure of 250 Pa for a period of 120±5 s and then thickness was measured after applying the pressure to the nearest 0.1 mm. To measure, each damping mat tested was loaded with a device exerting a pressure of 2 kPa for a period of 120±5 s and then thickness was measured after applying the pressure to the nearest 0.1 mm. To measure d50k each damping mat tested was loaded with a device exerting an additional pressure of 48 kPa (in addition to 2 kPa) for a period of 120 t 5 s and then thickness was measured after applying the pressure to the nearest 0.1 mm. Finally, to measure the thickness &, each damping mat tested was loaded only with the device exerting a pressure of 2 kPa (after removing the pressure of 48 kPa) for a period of 120 t 5 s and then thickness was measured to the nearest 0.1 mm. The thickness was determined as the distance measured between a rigid flat base plate on which the test specimen rests and a rigid flat pressure plate exerting different specified pressures on the top surface of the test specimen.

Workability: Each indicated material was formed by homogeneously mixing the liquid part and powder part with a high speed mixer for 3 minutes to prepare a trowelable mixture and a sprayable material. A concrete substrate surface was wetted before testing. Workability was evaluated by a skilled artisan levelling the surface of a fresh mixture of the indicated material with a steel trowel and visually assessing the smoothness of the material and the flatness of the material surface as applied and according to the following score:
Workability evaluation score: 0, not workable; 1, very poor; 2, poor; 3, acceptable; 4, good; 5, excellent.

TABLE 3
Formulations For The Acoustic Insulation Impedance Tube Test

| | | | EXAMPLE | | | | | | | | | | |
|---|---|---|---|---|---|---|---|---|---|---|---|---|---|
| Material | | Unit | 1* | 2* | 3* | 4* | 5* | 6 | 7 | 8* | 9 | 10* | 11* |
| Liquid | Hard styrene acrylic | Wt. % | 19.56 | | | | | | | | | | |
| part | emulsion polymer | | | | | | | | | | | | |
| | Soft styrene acrylic | Wt. % | 39.12 | | | | | | | | | | |
| | emulsion polymer | | | | | | | | | | | | |
| | Water | Wt. % | 39.12 | | | | | | | | | | |
| | Foam Stabilizer | Wt. % | 0.98 | | | | | | | | | | |
| | Foaming Agent | Wt. % | 0.14 | | | | | | | | | | |
| | Thickener | Wt. % | 0.59 | | | | | | | | | | |
| | Dispersant | Wt. % | 0.49 | | | | | | | | | | |
| Powder | EPDM Rubber powder | Wt. % | 100 | | | | 93.33 | 58.33 | 36.36 | | 40.00 | | 83.33 |
| part | (<80 mesh) | | | | | | | | | | | | |
| | Lightweight sand | Wt. % | | 100 | | 88.89 | | 33.33 | 54.55 | | 40.00 | 77.78 | |
| | SBR Recycled rubber | Wt. % | | | 100 | 11.11 | 6.67 | 8.33 | 9.09 | | | | |
| | powder | | | | | | | | | | | | |
| | Recycled (Black) tire | Wt. % | | | | | | | | 100 | 20.00 | 22.22 | 6.67 |
| | rubber powder | | | | | | | | | | | | |

| | | | | | | | | | | | |
|---|---|---|---|---|---|---|---|---|---|---|---|
| Liquid part/Powder part | 1.8 | 1.8 | 0.9 | 0.9 | 1.5 | 1.2 | 1.1 | 0.8 | 1 | 0.9 | 1.2 |
| Workability | 3 | 3 | 2 | 2 | 2 | 3 | 3 | 2 | 5 | 4 | 3 |

*Denotes Comparative Example.

TABLE 4
Formulations For The Compression Rate Test

| | | Example | | | |
|---|---|---|---|---|---|
| Material | | Units | 13 | 14* | 15* |
| Liquid | Hard styrene acrylic emulsion | Wt. % | 19.56 | 58.68 | 0 |
| part | polymer | | | | |
| | Soft styrene acrylic emulsion | Wt. % | 39.12 | 0 | 58.68 |
| | polymer | | | | |
| | Water | Wt. % | 39.12 | 39.12 | 39.12 |
| | Foam Stabilizer | Wt. % | 0.98 | 0.98 | 0.98 |
| | Foaming Agent | Wt. % | 0.14 | 0.14 | 0.14 |
| | Thickener | Wt. % | 0.59 | 0.59 | 0.59 |
| | Dispersant | Wt. % | 0.49 | 0.49 | 0.49 |
| Powder | Recycled (Black) tire rubber | Wt. % | 20.00 | 20.00 | 20.00 |
| part | powder (<0.5 mm) | | | | |
| | EPDM Rubber powder <80 | Wt. % | 40.00 | 40.00 | 40.00 |
| | mesh | | | | |
| | Wood flour A | Wt. % | 0 | 0 | 0 |
| | Wood flour B | Wt. % | 0 | 0 | 0 |
| | Lightweight sand | Wt. % | 40.00 | 40.00 | 40.00 |

| | | | |
|---|---|---|---|
| Liquid part/Powder part | 1 | 1 | 1 |

*Denotes Comparative Example.

TABLE 5
Results of The Impact Sound Insulation Test

| | EXAMPLE (thickness)¹ | | | | |
|---|---|---|---|---|---|
| | Fiber | | | | |
| | cement | 12B*^{, 2} | 12C*^{, 2} | 9B³ | 9C³ |
| | panel* | (3 mm) | (5 mm) | (3 mm) | (5 mm) |
| Sound noise Level/dB | 85 | 68 | 66 | 68 | 67 |

*Denotes Comparative Example.
¹Thickness is 5 mm unless otherwise indicated.
²Same material as in Comparative Example 12.
³Similar formulation to that of Example 9.

TABLE 6
Compression Rate Of Sound Damping Mat Samples

| | Example | | | | |
|---|---|---|---|---|---|
| | dL | dF | d50K | dB | Compression rate (%) |
| 13 | 6.7 | 6.7 | 6.6 | 6.7 | 1.5 |
| 14* | 5.3 | 5.3 | 5.1 | 5.3 | 3.8 |
| 15* | 4.7 | 4.7 | 4.3 | 4.6 | 8.5 |
| 12D*^{, 1} | 5.1 | 5.1 | 5.0 | 5.1 | 2.0 |

*Denotes Comparative Example.
¹Same formulation as in Comparative Example 12.

As shown in Table 5, above, sound noise levels resulting when the inventive damping mat of Example 9B and 9C were used are comparable to those obtained from precast PU foam mats in Comparative Examples 12B and 12C and much better than fiber cement.

As shown in Table 6, above, the compression rate resulting from testing the inventive damping mat of Example 13 made using a trowelable aqueous composition comprising a 1:1 weight ratio of rubbery composite component and aqueous polymer foam forming component was comparable to the rate obtained from precast PU foam mats in Comparative Example 12D and much better than the result obtained from pads made from Comparative Examples 14 (hard polymer only) and 15 (soft polymer only).

As shown in Table 7, below, the Inventive Examples 6 to 7 and 9 provided good workability and consistent sound damping from low to high frequencies. Inventive Example 6 provided sound damping at low frequencies that was comparable to the PU foam mat of Comparative Example 12. As shown in Comparative Examples 4 and 5, too much of the lightweight sand or crosslinked rubber hampers workability. In Comparative Example 5, workability remained an issue even though the pad was made using a trowelable aqueous composition comprising a 1:1.5 weight ratio of rubbery composite component and aqueous polymer foam forming component. As shown in Comparative Example 5, higher than a preferred amount of aqueous polymer foam forming component leads to inconsistent sound damping at low frequencies. The composition of Comparative Example 10 provides workability and sound damping but results in a composition having excessive compression for proper durability because it has too much of the lightweight sand.

TABLE 7
Sound Damping Mat Acoustic Insulation Impedence Tube Test Results

| | EXAMPLE (dB) | | | | | | | | | | | |
|---|---|---|---|---|---|---|---|---|---|---|---|---|
| F (Hz) | 1* | 2* | 3* | 4* | 5* | 6 | 7 | 8* | 9 | 10* | 11* | 12* |
| 100 | 3.62 | 3.828 | 11.743 | 20.943 | 13.384 | 11.377 | 15.35 | 10.579 | 21.872 | 21.374 | 9.023 | 12.84 |
| 125 | 3.608 | 3.788 | 9.971 | 20.853 | 11.055 | 11.435 | 15.399 | 10.824 | 21.791 | 21.422 | 7.766 | 11.533 |
| 160 | 4.168 | 3.796 | 10.089 | 20.676 | 11.654 | 11.394 | 15.392 | 9.761 | 21.418 | 21.285 | 8.234 | 9.827 |
| 200 | 4.565 | 3.785 | 12.076 | 20.492 | 14.027 | 10.93 | 15.288 | 9.128 | 20.766 | 21.038 | 9.902 | 9.762 |
| 250 | 4.856 | 3.789 | 14.506 | 20.189 | 16.108 | 9.666 | 14.87 | 10.425 | 19.054 | 20.532 | 11.232 | 11.268 |
| 315 | 5.124 | 3.813 | 16.114 | 19.732 | 17.476 | 9.076 | 13.854 | 12.278 | 16.351 | 19.657 | 11.995 | 13.159 |
| 400 | 5.415 | 3.689 | 17.505 | 18.724 | 18.521 | 10.434 | 12.12 | 14.283 | 15.02 | 17.284 | 12.709 | 14.941 |
| 500 | 5.735 | 3.437 | 18.735 | 16.432 | 19.31 | 11.753 | 11.861 | 16.246 | 17.337 | 14.916 | 13.159 | 16.506 |
| 630 | 6.165 | 3.929 | 19.517 | 14.479 | 19.735 | 12.86 | 14.306 | 17.94 | 20.169 | 14.903 | 13.385 | 17.642 |
| 800 | 6.754 | 4.241 | 20.064 | 16.826 | 20.524 | 13.89 | 16.013 | 19.404 | 22.382 | 17.402 | 14.068 | 19.257 |
| 1000 | 7.178 | 4.359 | 21.433 | 19.011 | 21.567 | 14.57 | 16.952 | 20.356 | 23.784 | 19.409 | 14.611 | 20.791 |
| 1250 | 7.642 | 4.497 | 22.757 | 20.091 | 22.44 | 14.968 | 17.63 | 21.591 | 24.904 | 20.625 | 14.983 | 22.219 |
| 1600 | 8.294 | 4.775 | 23.526 | 20.544 | 23.799 | 15.813 | 18.346 | 22.906 | 26.553 | 21.261 | 15.413 | 22.49 |
| 2000 | 8.75 | 4.89 | 24.74 | 20.71 | 24.825 | 16.596 | 18.867 | 23.449 | 27.863 | 21.961 | 16.083 | 22.905 |
| 2500 | 9.399 | 5.218 | 26.137 | 21.097 | 25.818 | 17.438 | 19.339 | 23.863 | 28.951 | 22.867 | 16.654 | 24.434 |
| 3150 | 10.139 | 5.627 | 27.928 | 21.987 | 27.254 | 18.646 | 20.465 | 25.604 | 29.735 | 24.74 | 17.419 | 26.491 |
| 4000 | 10.601 | 5.605 | 29.167 | 23.163 | 28.239 | 19.471 | 20.999 | 26.67 | 30.848 | 27.538 | 17.806 | 28.108 |

*Denotes Comparative Example.

We claim:

1. A trowelable aqueous composition of an aqueous polymer foam forming component and a rubbery composite component, comprising:
as the aqueous polymer foam forming component:
A) from 10 to 60 wt. % of one or more hard vinyl or acrylic aqueous emulsion polymers having measured glass transition temperature (measured Tgh) of from 5 to 40° C. as measured by differential scanning calorimetry (DSC) comprising heating to 160° C., rapidly cooling at 10° C./minute to −80° C., and then collecting DSC curve data while ramping the temperature at 10° C./minute up to 160° C., and recording the midpoint of the inflection of the resulting DSC curve as the Tgh,
B) from 5 to 50 wt. % of one or more soft vinyl or acrylic aqueous emulsion polymers having a measured Tg (measured Tgs) of from 0 to −35° C. as measured by differential scanning calorimetry (DSC) comprising heating to 160° C., rapidly cooling at 10° C./minute to −80° C., and then collecting DSC curve data while ramping the temperature at 10° C./minute up to 160° C., and recording the midpoint of the inflection of the resulting DSC curve as the Tgs;
C)(i) from 0.5 to 3 wt. % of a foam stabilizer of a 12 to 24 carbon organic acid salt, and C)(ii) from 0.05 to 0.75 wt. % of an organic foaming agent; and,
as the rubbery composite component:
D)(i) from 20 to 60 wt. % of a lightweight inorganic aggregate having a sieve particle size of from 0.3 to 4 mm and having a density of from 0.18 to 0.4 g/cm³; and,
D)(ii) from 20 to 60 wt. % of crosslinked rubber (a) granules having a sieve particle size of from 0.5 to 4 mm or crosslinked rubber (b) particles having a sieve particle size of from 0.1 to less than 0.5 mm, or a mixture of the (a) granular crosslinked rubber particles and the (b) finely divided crosslinked rubber particles in a weight ratio of (a):(b) of from 99:1 to 20:80,
wherein all wt. % s in the trowelable aqueous composition add up to 100% and are based on the total weight of all materials used to form the trowelable aqueous composition.

2. The trowelable aqueous composition as claimed in claim 1, wherein the measured Tg (measured Tgh) of the A) hard vinyl or acrylic aqueous emulsion polymer and the measured Tg (measured Tgs) of the B) soft vinyl or acrylic aqueous emulsion polymer differ by from 15° C. to 75° C.

3. The trowelable aqueous composition as claimed in claim 1, wherein the measured Tgh ranges from 10 to 35° C., and the measured Tgs ranges from −8 to −35° C.

4. The trowelable aqueous composition as claimed in claim 1, wherein the B) soft vinyl or acrylic aqueous emulsion polymer in the aqueous polymer foam forming component comprises from 7 to 40 wt. %, based on the total weight of all materials used to form the trowelable aqueous composition.

5. The trowelable aqueous composition as claimed in claim 1, wherein the solids weight ratio of the total A) hard vinyl or acrylic aqueous emulsion polymer to the total B) soft vinyl or acrylic aqueous emulsion polymer ranges from 2:3 to 6:1.

6. The trowelable aqueous composition as claimed in claim 1, comprising calcium stearate as the C(i) foam stabilizer.

7. The trowelable aqueous composition as claimed in claim 1, comprising alkyl polyglucoside as the C)(ii) organic foaming agent.

8. The trowelable aqueous composition as claimed in claim 1, wherein the D)(i) lightweight inorganic aggregate is chosen from a lightweight porous sand, mesoporous silica, mesostructured silica or expanded clay aggregate.

9. The trowelable aqueous composition as claimed in claim 1, wherein the D)(ii) (a) the crosslinked rubber granules comprise ethylene propylene diene (EPDM) rubber granules or ethylene propylene (EPM) rubber granules, or the D)(ii)(b) the crosslinked rubber particles comprise ethylene propylene diene (EPDM) rubber powder or ethylene propylene (EPM) rubber powder, or both.

10. The trowelable aqueous composition as claimed in claim 1, further comprising, in the aqueous polymer foam forming components,
from 0.1 to 1.5 wt. % of one or more hydrophobically modified anionic thickeners; and
from 0.1 to 1.5 wt. % of one or more dispersants.

11. A. method for using the trowelable aqueous compositions as claimed in claim 1, comprising:
mixing the D)(i) lightweight inorganic aggregate and D)(ii) the crosslinked rubber (a) granules or (b) finely divided crosslinked rubber particles, or the mixture of (a) granules of crosslinked rubber and (b) finely divided crosslinked rubber particles to form a rubbery composite component;
mixing the vinyl or acrylic aqueous emulsion polymer polymers A) and B), the C)(i) foam stabilizer, and C)(ii) the organic foaming agent to form an aqueous polymer foam forming component;
combining the rubbery composite component and the aqueous polymer foam forming component to make a trowelable mixture;
applying the trowelable mixture to a substrate to form a mat layer; and,
drying or curing the mat layer.
